(19) United States
(12) Patent Application Publication
(10) Pub. No.: US 2025/0047382 A1
(43) Pub. Date: Feb. 6, 2025

(54) OPTICAL TRANSMISSION SYSTEM, OPTICAL TRANSMISSION METHOD AND PROGRAM

(71) Applicant: NIPPON TELEGRAPH AND TELEPHONE CORPORATION, Tokyo (JP)

(72) Inventors: Shimpei SHIMIZU, Musashino-shi (JP); Takayuki KOBAYASHI, Musashino-shi (JP); Yutaka MIYAMOTO, Musashino-shi (JP)

(73) Assignee: NIPPON TELEGRAPH AND TELEPHONE CORPORATION, Tokyo (JP)

(21) Appl. No.: 18/708,981

(22) PCT Filed: Nov. 17, 2021
(86) PCT No.: PCT/JP2021/042238

§ 371 Date: May 9, 2024

(51) Int. Cl. H04B 10/2507; H04B 10/291

(52) U.S. Cl. CPC H04B 10/2507; H04B 10/291

(57) ABSTRACT

An optical transmission system, comprising:

a transmission unit that maximizes a frequency interval between a plurality of channel components within a transmission band, and generates a first optical signal that is an optical signal in which the plurality of channel components are wavelength-division multiplexed, a first transmission path for transmitting the first optical signal, a phase conjugate conversion unit that generates a second optical signal by inverting a spectrum of the first optical signal, and a second transmission path for transmitting the second optical signal. The first transmission path and the second transmission path wavelength-disperse the plurality of channel components of the first optical signal and the second optical signal. The first transmission path may include one or more first optical relay units for amplifying and relaying the first optical signal. The second transmission path may include one or more second optical relay units for amplifying and relaying the second optical signal.

### TECHNICAL FIELD

The present invention relates to an optical transmission system, an optical transmission method and a program.

### BACKGROUND ART

In a case where an optical signal is transmitted over a long distance by using an optical fiber, an optical amplification relay transmission system may be employed in some cases for compensating for optical loss occurring in the optical fiber. In the optical amplification relay transmission system, an optical amplification unit amplifies an optical signal. Therefore, the transmission band of the optical signal in the optical transmission system is limited to the amplification band of the optical amplification unit.

An optical fiber to which a rare earth element is added is used for the optical amplification unit. An erbium-doped optical fiber amplifier (EDFA) is one of typical rare earth doped optical amplification units. The amplification band of the erbium-doped optical fiber amplifier is about 4 THz in the band called “C-band” or “L-band”. Therefore, the amplification band of the optical signal in the optical transmission system is designed to be about 4 THz.

In the centralized amplification relay system, erbium-doped optical fiber amplifiers or the like arranged at predetermined intervals on a transmission path amplify an optical signal. On the other hand, in the distributed amplification relay system, an optical signal being transmitted through a transmission path (optical fiber) is amplified by Raman optical amplification or the like. The transmission power of the optical signal transmitted in the distributed amplification relay system is held higher than the transmission power of the optical signal transmitted in the centralized amplification relay system. Therefore, in the distributed amplification relay system, a high optical signal-to-noise ratio (OSNR) is maintained in an optical signal after transmission.

In the distributed amplification relay system, in order to sufficiently compensate for the transmission loss in the transmission path, it is necessary to input excitation light having a very strong light intensity to the optical fiber. Therefore, the application area is limited from the viewpoint of securing safety. Thus, the light intensity of the excitation light of the distributed amplification relay system is suppressed, and the loss which is not compensated for by the distributed amplification relay system is compensated for by the centralized amplification relay system. Such a hybrid amplification relay system may be used.

The transmission distance and the relay interval of the optical signal in the amplification relay transmission system are limited by the amplified spontaneous emission (ASE) noise outputted from the optical amplification unit. When the optical signal-to-noise ratio is deteriorated by spontaneous emission optical noise, it is necessary to reproduce and relay the optical signal. In the regenerative relay, the optical signal is converted into an electrical signal, the electrical signal is re-converted into an optical signal, and the re-converted optical signal is re-transmitted.

On the other hand, in order to construct an economical optical network, it is important that the interval between the amplification relays and the interval between the regeneration relays be extended. In order to suppress the deterioration of the optical signal-to-noise ratio due to the transmission loss increased by the extension and the spontaneous emission optical noise increased according to the number of times of amplification relays, it is necessary to increase the transmission power (optical intensity) of the optical signal.

However, as the transmission power increases, the nonlinear optical effect in the optical fiber becomes more apparent. Since the refractive index of the optical fiber as the transmission medium is changed by the nonlinear optical effect, waveform distortion is generated in the optical signal. Therefore, the maximum transmission capacity and transmission distance of the optical signal are determined according to the trade-off between the improvement of the optical signal-to-noise ratio by the transmission power and the suppression of waveform distortion by the nonlinear optical effect. Hereinafter, the signal-to-noise ratio is a quantitative index of signal quality including noise due to the nonlinear optical effect and optical signal-to-noise ratio.

The nonlinear noise is distinguished based on a component on which the nonlinear noise acts. Phase noise due to the nonlinear optical effect (nonlinear phase noise) of self-phase modulation (SPM) is caused by the optical power of the transmission channel itself which is subjected to waveform distortion. Phase noise due to the nonlinear optical effect (nonlinear phase noise) of cross-phase modulation (XPM) is generated by the optical power of other transmission channels subjected to wavelength-division multiplexing (WDM).

The transmission performance limit due to the nonlinear optical effect is called a nonlinear Shannon limit. The nonlinear Shannon limit is a major problem in improving the utilization efficiency of the frequency in an optical transmission system and extending the transmission distance of an optical signal.

On the other hand, since the waveform of the optical signal during transmission changes due to wavelength dispersion, nonlinear phase noise is averaged. Such an effect is called walk-off. The channel components whose frequencies are separated from each other have a larger waveform change due to wavelength dispersion than the channel components whose frequencies are close to each other. Therefore, the cross-phase modulation, which is the effect of a wide band, is particularly strongly affected by walk-off. Therefore, in optical fiber transmission, an optical fiber having no zero-dispersion wavelength within the transmission band of an optical signal is generally used so that the occurrence of nonlinear distortion due to cross-phase modulation is suppressed by walk-off. The zero-dispersion wavelength is a wavelength at which the wavelength dispersion becomes zero.

Wavelength dispersion may induce spread of pulses of the optical signal, and spread of pulses may induce inter-code interference. In order to suppress the inter-code interference, it is necessary to compensate for the wavelength dispersion in the demodulation of the optical signal. Dispersion management transmission is widely used as a compensation method for wavelength dispersion. In the dispersion management transmission, an optical fiber having characteristics in a main transmission path and an optical fiber (optical fiber for dispersion compensation) having characteristics (wavelength dispersion) opposite to the characteristics are combined. However, in the dispersion management transmission, the optical transmission system transmits the optical signal while compensating for the wavelength dispersion of the optical signal. Therefore, the influence of walk-off is reduced, and nonlinear noise is increased.

In recent years, the practical use of digital coherent optical transmission has been made. In the digital coherent optical transmission, a communication device on the reception side executes digital signal processing. Thus, the wavelength dispersion accumulated in the optical signal is compensated for collectively. Since the communication device on the reception side compensates for wavelength dispersion all at once by digital signal processing, dispersion management is not required to be executed on a transmission path, and noise caused by cross-phase modulation generated in an optical signal during transmission is suppressed by large walk-off. Such a transmission system is called a non-distributed management transmission system.

As one of the optical amplification units, there is an optical parametric amplifier (OPA). The optical parametric amplifier amplifies an input optical signal by utilizing a nonlinear optical effect in a nonlinear optical medium. The nonlinear optical medium is, for example, lithium niobate which is a second-order nonlinear medium or an optical fiber which is a third-order nonlinear medium.

NPD 1 discloses an optical parametric amplifier using periodically poled lithium niobate (PPLN) as an amplification medium (see NPD 1). Such an optical parametric amplifier achieves both a wide band property and a gain. For example, an amplification relay transmission which achieves both a wide band property of “over 10 THz” and an amplification gain “15 dB” has been demonstrated.

### CITATION LIST

### Non Patent Document

[NPD 1] T. Kobayashi et al., “Wide-band Inline-amplified WDM Transmission Using PPLN-based Optical Parametric Amplifier with the optical bandwidth over 10 THz,” IEEE J. Lightwave Technol., vol. 39, No. 3, pp. 787-794, February 2021.

### SUMMARY OF INVENTION

### Technical Problem

In the optical parametric amplifier, when an optical signal is amplified, phase conjugate light is generated at a frequency determined by a frequency relationship between the optical signal and excitation light. This phase conjugate light is called an idler light. The phase conjugate light is a complete copy of an input optical signal except for a point of phase conjugate. That is, the phase conjugate light has data and noise components of an input optical signal (original optical signal).

Therefore, one of the optical signal (original optical signal) input to the optical parametric amplifier and the phase conjugate light is selected by, for example, a bandpass filter. The selected optical signal or phase conjugate light is transmitted to a stage subsequent to the optical parametric amplifier. When the phase conjugate light is selected, phase conjugate conversion called optical phase conjugation (OPC) is performed on the optical signal input to the optical parametric amplifier.

Thus, a phase conjugate conversion unit (amplification relay unit) having an optical parametric amplifier executes phase conjugate conversion and extraction of phase conjugate light. Thus, the extracted phase conjugate light is transmitted to the subsequent stage of the phase conjugate conversion unit. The distortion in the phase direction generated in the optical signal inputted to the optical parametric amplifier is compensated for, for example, through the following processes (A1) to (A4). An optical signal that is wavelength-division multiplexed is hereinafter referred to as a “wavelength multiplexed signal”.
(A1) In a transmission path of a wavelength multiplexed signal (WDM signal), phase rotation occurs in the wavelength multiplexed signal due to nonlinear optical effect and wavelength dispersion of a transmission medium (optical fiber).
(A2) The phase conjugate conversion unit converts (phase conjugate conversion) the wavelength multiplexed signal input from the transmission path of the stage preceding the phase conjugate conversion unit into phase conjugate light. A sign of phase rotation (positive or negative) of the input wavelength multiplexed signal is different from a sign of phase rotation of the converted phase conjugate light.
(A3) A transmission path at a subsequent stage of the phase conjugate conversion unit transmits phase conjugate light. In the transmission path of the phase conjugate light, phase rotation occurs in the phase conjugate light due to nonlinear optical effect and wavelength dispersion, similarly to the transmission path of the wavelength multiplexed signal (original optical signal) input to the phase conjugate conversion unit.
(A4) The sign of phase rotation generated in the optical signal is the same in each transmission path. The phase rotation of the wavelength multiplexed signal (original optical signal) in the transmission path of the preceding stage of the phase conjugate conversion unit is inverted by phase conjugate conversion. Thus, the phase rotation of the phase conjugate light is canceled out in the transmission path at the subsequent stage of the phase conjugate conversion unit.

By performing phase conjugate conversion through the processes (A1) to (A4), it is possible to compensate for a nonlinear optical effect and phase rotation derived from wavelength dispersion. Therefore, phase conjugate conversion has attracted attention as a technique for breaking the conventional nonlinear Shannon limit.

In order to completely compensate for the nonlinear phase noise, it is necessary that the amount of phase rotation generated in the preceding stage of the phase conjugate conversion unit coincide with the amount of phase rotation generated in the subsequent stage of the phase conjugate conversion unit. The nonlinear phase noise includes noise due to an interaction between signals depending on the modulated data and noise having random fluctuation caused by an action between the optical signal and the noise.

The nonlinear phase noise due to the interaction between signals is determined according to the transition of optical intensity (optical power) during transmission (hereinafter referred to as “power map”) and the transition of wavelength dispersion (hereinafter referred to as “dispersion map”). In order to match the amount of phase rotation generated in the preceding stage of the phase conjugate conversion unit with the amount of phase rotation generated in the subsequent stage of the phase conjugate conversion unit, the position of the phase conjugate conversion unit may be set as an object axis (boundary) so that the power map is symmetrical and the dispersion map is symmetrical.

When the wavelength dispersion coefficient of the preceding stage of the phase conjugate conversion unit is the same as the wavelength dispersion coefficient of the subsequence stage of the phase conjugate conversion unit, the dispersion map becomes symmetrical with the position of the phase conjugate conversion unit as an object axis. Therefore, it is important that the power map is symmetrical with respect to the position of the phase conjugate conversion unit as an object axis.

However, in the optical transmission system of the concentrated amplification relay system, since the power map is sawtooth-shaped according to the transmission distance of the optical signal, it is difficult to secure the symmetry of the power map with the position of the phase conjugate conversion unit as the target axis. On the other hand, in the distributed amplification relay system, the symmetry of the power map can be secured to some extent. Therefore, the effect of nonlinear noise compensation by phase conjugate conversion in the distributed amplification relay system is greater than the effect of nonlinear noise compensation by phase conjugate conversion in the concentrated amplification relay system.

In this way, in particular, in the optical transmission system of the concentrated amplification relay system, it is difficult to secure the symmetry of the power map, so that the compensation of the nonlinear noise by the phase conjugate conversion is incomplete. Usually, phase noise due to cross-phase modulation is suppressed to some extent by walk-off due to wavelength dispersion. However, in an optical transmission system having a phase conjugate conversion unit, since an optical signal is transmitted while compensating for wavelength dispersion, the influence of walk-off is small like dispersion management transmission.

On the other hand, since the sign of the phase rotation of the optical signal in the preceding stage of the phase conjugate conversion unit is different from the sign of the phase rotation of the optical signal in the subsequence stage of the phase conjugate conversion unit, the phase rotation of the optical signal is canceled. Therefore, the amount of noise of the nonlinear phase in the communication device on the reception side is determined by the balance between the amount of phase noise increased by the reduction of the influence of walk-off and the amount of cancellation.

Most of nonlinear noise derived from self-phase modulation having little dependency on the power map and the dispersion map is compensated for by phase conjugate conversion even when the power map and the dispersion map are asymmetrical. For these reasons, in an optical transmission system (asymmetric system) of a concentrated amplification relay system, nonlinear noise derived from cross-phase modulation becomes dominant by applying phase conjugate conversion. As described above, there is a problem that the transmission distance of the optical signal cannot be improved.

In view of the above circumstances, an object of the present invention is to provide an optical transmission system, an optical transmission method, and a program capable of improving the transmission distance of optical signals.

### Solution to Problem

An aspect of the present invention is an optical transmission system a transmission unit that maximizes a frequency interval between a plurality of channel components within a transmission band, and generates a first optical signal that is an optical signal in which the plurality of channel components are wavelength-division multiplexed, a first transmission path for transmitting the first optical signal, a phase conjugate conversion unit that generates a second optical signal by inverting a spectrum of the first optical signal, and a second transmission path for transmitting the second optical signal.

An aspect of the present invention is an optical transmission method executed to be executed by an optical transmission system, the method including a transmission unit that maximizes a frequency interval between a plurality of channel components within a transmission band, and generates a first optical signal that is an optical signal in which the plurality of channel components are wavelength-division multiplexed, a first transmission step of transmitting the first optical signal, a phase conjugate conversion step of generating a second optical signal by inverting a spectrum of the first optical signal, and a second transmission step of transmitting the second optical signal.

An aspect of the present invention is a program for causing a computer to serve as the optical transmission system.

### Advantageous Effects of Invention

According to the present invention, it is possible to improve the transmission distance of optical signals.

### BRIEF DESCRIPTION OF DRAWINGS

FIG. 1 is a diagram illustrating a configuration example of an optical transmission system according to a first embodiment.

FIG. 2 is a diagram illustrating an example of change in the amount of wavelength dispersion in the first embodiment.

FIG. 3 is a diagram illustrating a configuration example of a phase conjugate conversion unit in the first embodiment.

FIG. 4 is a flowchart illustrating an operation example of an optical transmission system in the first embodiment.

FIG. 5 is a diagram illustrating an example of each frequency arrangement of an optical signal before phase conjugate conversion and an optical signal after phase conjugate conversion in a second embodiment.

FIG. 6 is a diagram illustrating an example of a relationship between wavelength dispersion and signal-to-noise ratio in the second embodiment.

FIG. 7 is a diagram illustrating an example of a relationship between transmission path input power and the signal-to-noise ratio in the second embodiment.

FIG. 8 is a diagram illustrating a configuration example of a phase conjugate conversion unit (complementary spectrum inversion type phase conjugate conversion unit) in a third embodiment.

FIG. 9 is a diagram illustrating an example of each frequency arrangement of an optical signal before the phase conjugate conversion and an optical signal after the phase conjugate conversion in the third embodiment.

FIG. 10 is a diagram illustrating a hardware configuration example of a communication device in each embodiment.

### DESCRIPTION OF EMBODIMENTS

### (Overview)

The efficiency of generation of nonlinear noise derived from cross-phase modulation depends on the interval (arrangement) of channel components of the wavelength multiplexed signal on the frequency axis. Therefore, an optical transmission system which performs phase conjugate conversion is more strongly affected by the interval of channel components than an optical transmission system which does not perform phase conjugate conversion.

In an optical transmission system that performs phase conjugate conversion, the wider the interval between channel components, the lower the influence of cross-phase modulation. In the following description, the noise derived from the self-phase modulation becomes more dominant because the influence of the cross-phase modulation is reduced with respect to the noise of the nonlinear phase.

Thus, the performance of compensating for the noise of the nonlinear phase of the phase conjugate conversion is improved. In addition, long-distance transmission exceeding the nonlinear Shannon limit in an optical transmission system which does not execute phase conjugate conversion is realized.

An embodiment of the present invention will be described in detail with reference to the diagrams.

### First Embodiment

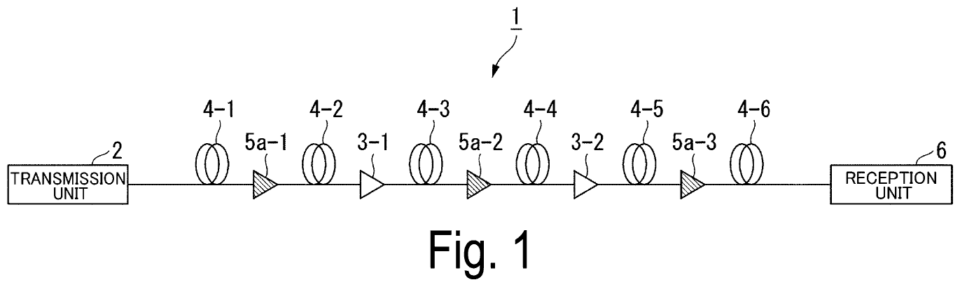

FIG. 1 is a diagram illustrating a configuration example of an optical transmission system 1. The optical transmission system 1 is a system that transmits an optical signal (wavelength multiplexed signals). The optical transmission system 1 includes a transmission unit 2, a plurality of optical relay units 3, a plurality of optical transmission paths 4, one or more phase conjugate conversion units 5a, and a reception unit 6. The optical relay unit 3 and the phase conjugate conversion unit 5a are cascaded using the optical transmission path 4.

For example, the optical transmission path 4-1, the phase conjugate conversion unit 5a-1, and the optical transmission path 4-2 configure one set. The optical transmission system 1 may include a plurality of such sets. For example, the optical transmission path 4-3, the phase conjugate conversion unit 5a-2, and the optical transmission path 4-4 configure another set. Such a plurality of sets are cascaded in the optical transmission system 1.

In FIG. 1, the optical transmission path 4-1 (first transmission path) includes the transmission unit 2 that transmits a wavelength multiplexed signal (first optical signal). The optical transmission path 4-2 (second transmission path) includes one or more optical relay units 3-1 that amplify and relay a new wavelength multiplexed signal (second optical signal) that is phase conjugate light.

The transmission unit 2 is a communication device on a transmission side. The transmission unit 2 generates a wavelength multiplexed signal. In the wavelength multiplexed signal, channel components of a plurality of wavelengths are multiplexed (wavelength-division multiplexed). The transmission unit 2 transmits the wavelength multiplexed signal to the phase conjugate conversion unit 5a-1.

It is desirable that the interval between the channel components of the wavelength multiplexed signal is maximized in the transmission band while the number of the channel components required in the optical transmission system 1 is secured. The transmission band is predetermined according to the band or the like of an amplifier repeater (the optical relay unit 3 and the phase conjugate conversion unit 5a). The transmission unit 2 transmits a wavelength multiplexed signal in which the interval of channel components is widened to a predetermined threshold or more within a predetermined transmission band to the phase conjugate conversion unit 5a-1. The maximum value “Δfₘₐₓ” of the interval between the channel components of the wavelength multiplexed signal on the frequency axis is determined as shown by Equation (1).

$$Δ {f}_{max} = W / N \qquad ( 1 )$$

Here, “N” represents the number of channel components necessary for the optical transmission system. “W” represents a transmission band. The transmission band is predetermined according to the band or the like of the amplification repeater (the optical relay unit 3 and the phase conjugate conversion unit 5a) in the optical transmission system 1.

The transmission unit 2 adjusts an interval of channel components of the wavelength multiplexed signal by adjusting an output wavelength of a light source for generating the wavelength multiplexed signal for each channel component. The transmission unit 2 may adjust the interval (oscillation frequency) of the channel components of the wavelength multiplexed signal using a light source having an oscillation frequency (oscillation wavelength) different for each channel component for generating the wavelength multiplexed signal.

Since the interval of channel components of the wavelength multiplexed signal is arranged on the frequency axis at an interval of the maximum value “Δfₘₐₓ”, the effect of phase conjugate conversion is maximized. Furthermore, the transmission performance is greatly improved.

In order to improve the signal-to-noise ratio, amplification and relay of the optical signal may be executed a predetermined number of times in each transmission path in the preceding stage and the subsequence stage of the phase conjugate conversion unit 5a. For example, the number of optical relay units 3-1 of the optical transmission path 4-3 in the preceding stage of the phase conjugate conversion unit 5a-2 may be equal to the number of optical relay units 3-2 of the optical transmission path 4-4 in the subsequent stage of the phase conjugate conversion unit 5a-2. In FIG. 1, processing for generating the phase conjugate light of the wavelength multiplexed signal is executed, for example, every two spans (for example, two optical transmission paths 4).

In FIG. 1, the processes (one set) from (A1) to (A4) are executed in a unit from the optical transmission path 4 of the preceding stage of the phase conjugate conversion unit 5a to the optical transmission path 4 of the subsequence stage of the phase conjugate conversion unit 5a. That is, one phase conjugate conversion unit 5a and one optical relay unit 3 are used as one example in the processes (A1) to (A4). The number of the optical relay units 3 may not be limited to a specific number, and more optical relay units 3 may be used in the processes (A1) to (A4). In FIG. 1, as an example, a wavelength multiplexed signal is transmitted to the reception unit 6 in six spans including two amplification relays by the optical relay unit 3 and three amplification relays by the phase conjugate conversion unit 5a.

Further, since the gain of the optical parametric amplifier for performing the phase conjugate conversion is not always sufficient for amplification relay, an amplification repeater may be required separately from the optical relay unit 3. That is, in order to gain the relay gain of the optical signal, the phase conjugate conversion unit 5a may include an amplification repeater (for example, an erbium-doped optical fiber amplifier). In this case, an amplification repeater provided in the phase conjugate conversion unit 5a executes amplification relay similarly to the optical relay unit 3, and an optical parametric amplifier provided in the phase conjugate conversion unit 5a executes phase conjugate conversion. In a case where the gain of the optical parametric amplifier is sufficient for amplification relay, another amplification relay is not required, and the phase conjugate conversion unit 5a can be configured only by the optical parametric amplifier performing phase conjugate conversion.

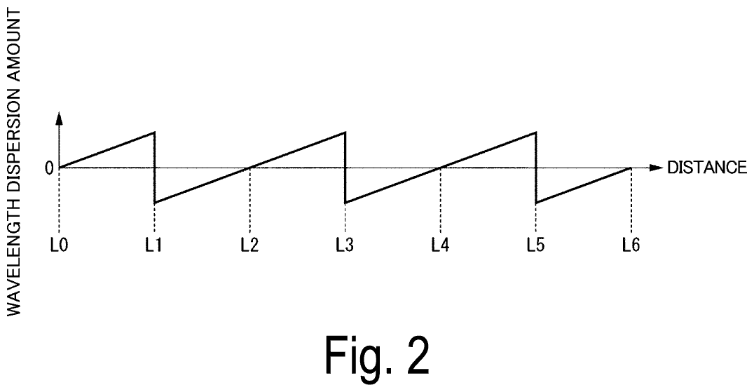

FIG. 2 is a diagram (wavelength dispersion map) illustrating an example of changes in the wavelength dispersion amount in the first embodiment. The transmission unit 2 generates a wavelength multiplexed signal. “L0” represents the position of the transmission unit 2. “L1” represents a distance from the transmission unit 2 to the phase conjugate conversion unit 5a-1. In other words, “L1” represents the position of the phase conjugate conversion 5a-1 from the transmission unit 2.

“L2” represents a distance from the transmission unit 2 to the optical relay unit 3-1. In other words, “L2” represents the position of the optical relay unit 3-1. “L3” represents a distance from the transmission unit 2 to the phase conjugate conversion unit 5a-2. In other words, “L3” represents the position of the phase conjugate conversion unit 5a-2. “L4” represents a distance from the transmission unit 2 to the optical relay unit 3-2. In other words, “L4” represents the position of the optical relay unit 3-2.

“L5” represents a distance from the transmission unit 2 to the phase conjugate conversion unit 5a-3. In other words, “L5” represents the position of the phase conjugate conversion unit 5a-3. “L6” represents a distance from the transmission unit 2 to the reception unit 6. In other words, “L6” represents the position of the reception unit 6.

The optical transmission paths 4 having the same length and the same characteristics are arranged in the preceding stage and the subsequent stage of the phase conjugate conversion unit 5a for executing optical parametric amplification. That is, the difference between the distance “L1” and the distance “L0” is equal to the difference between the distance “L2” and the distance “L1”. The difference between the distance “L3” and the distance “L2” is equal to the difference between the distance “L4” and the distance “L3”. A difference between the distance “L5” and the distance “L4” is equal to a difference between the distance “L6” and the distance “L5”. The criterion for determining whether the length is the same is predetermined. Further, a criterion for determining whether the characteristics are the same is predetermined.

In the optical transmission system 1 in which the processing of phase conjugate conversion is executed, for example, every two spans, the span length before the processing of phase conjugate conversion may be equal to the span length after the processing of phase conjugate conversion, and the number of times of amplification relay before the processing of phase conjugate conversion may be equal to the number of times of amplification relay after the processing of phase conjugate conversion. In the optical transmission system 1, the number of times that the phase conjugate conversion processing (processing for generating phase conjugate light) is executed is not limited to a specific number of times. For example, in the optical transmission system 1 for amplifying and relaying an optical signal in six spans, even in a case where phase conjugate conversion is executed for every three spans, the wavelength dispersion map becomes symmetrical with the position of the phase conjugate conversion unit 5a as a symmetry axis.

Referring to FIG. 1 again, the description of the configuration example of the optical transmission system 1 will be continued. The transmission unit 2 transmits the wavelength multiplexed signal to the phase conjugate conversion unit 5a-1. The optical relay unit 3 compensates for loss generated in the wavelength multiplexed signal in the optical transmission path 4. The optical relay unit 3 compensates for loss generated in the phase conjugate light in the optical transmission path 4.

The optical transmission path 4 has a transmission path such as an optical fiber. In the optical transmission path 4, signal distortion due to a nonlinear optical effect occurs in the wavelength multiplexed signal. The optical transmission path 4 has wavelength dispersibility for all channel components of the wavelength multiplexed optical signal so that any channel component of the wavelength multiplexed optical signal does not become zero dispersion. In addition, the optical transmission path 4 has wavelength dispersibility for all channel components of the phase conjugate light so that any channel component of the phase conjugate light does not become zero dispersion.

The phase conjugate conversion unit 5a collectively converts the wavelength multiplexed signal into phase conjugate light by phase conjugate conversion called optical phase conjugation. The wavelength multiplexed signal is transmitted while compensating for the wavelength dispersion of the wavelength multiplexed signal by the effect of the phase conjugate conversion.

The reception unit 6 is a communication device on the reception side. The reception unit 6 receives the phase conjugate light of the wavelength multiplexed signal from the phase conjugate conversion unit 5a-3. The reception unit 6 executes predetermined reception processing on the phase conjugate light of the wavelength multiplexed signal. For example, the reception unit 6 demodulates modulated data in the phase conjugate light.

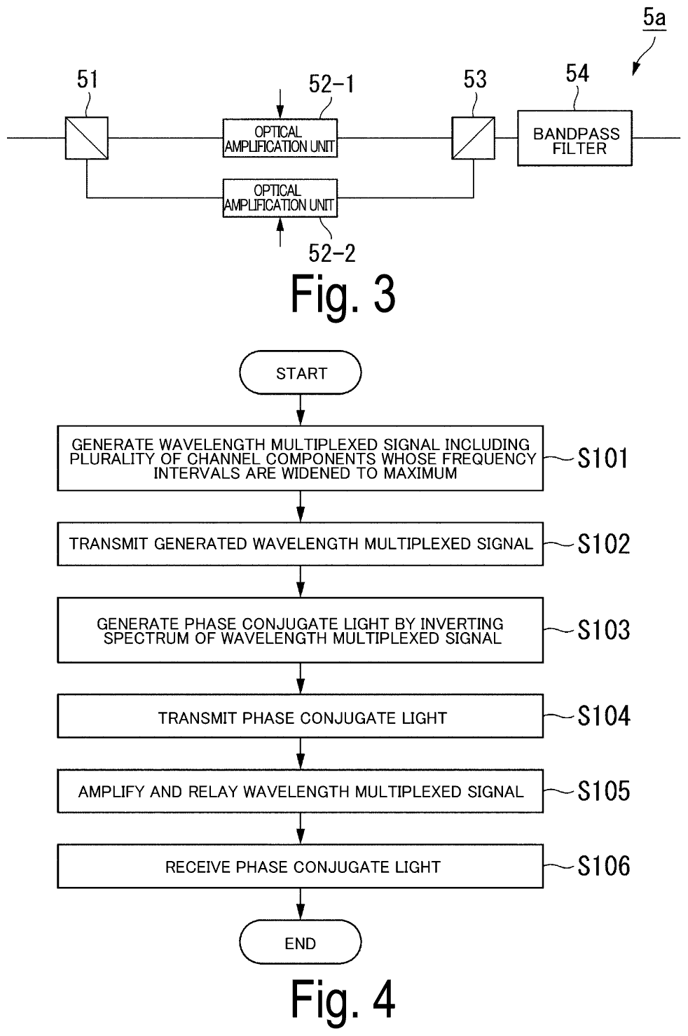

FIG. 3 is a diagram illustrating a configuration example of the phase conjugate conversion unit 5a in the first embodiment. Generally, the process of optical parametric amplification has polarization dependence. Therefore, the phase conjugate conversion unit 5a has a configuration of polarization diversity. That is, the phase conjugate conversion unit 5a is provided with a polarization demultiplexing unit 51, two optical amplification units 52, a polarization multiplexing unit 53, and a bandpass filter 54. The optical amplification unit 52 has a nonlinear medium (nonlinear optical medium).

The polarization diversity configuration in the phase conjugate conversion unit 5a may be the polarization diversity configuration shown in Reference 1 (T. Umeki, O. Tadanaga, M. Asobe, Y. Miyamoto and H. Takenouchi., “First demonstration of high-order QAM signal amplification in PPLN-based phase sensitive amplifier.”), for example.

The polarization demultiplexing unit 51 divides the input wavelength multiplexed signal into two orthogonal polarization components. The excitation light is input to each optical amplification unit 52. Each optical amplification unit 52 multiplexes the polarization component and the excitation light by using a wavelength-division multiplexing coupler, a dichroic mirror and the like. In each optical amplification unit 52, the multiplexed polarization component and excitation light are input to a nonlinear medium. The optical amplification unit 52 (nonlinear medium) executes optical parametric amplification for each polarization component by using the excitation light. The nonlinear medium may be a third-order nonlinear medium such as an optical fiber or a second-order nonlinear medium such as lithium niobate. At the output end of the nonlinear medium, the excitation light is separated from the polarization component by using a wavelength-division multiplexing coupler, a dichroic mirror, or the like.

The polarization multiplexing unit 53 re-synthesizes the two-polarization components. The bandpass filter 54 extracts phase conjugate light (idler light) generated by optical parametric amplification from the re-synthesized two-polarization component.

Next, an operation example of the optical transmission system 1 will be described.

FIG. 4 is a flowchart illustrating an operation example of the optical transmission system 1 in the first embodiment. The transmission unit 2 maximizes the frequency interval between the plurality of channel components within a transmission band, and generates a first optical signal which is an optical signal in which the plurality of channel components are wavelength-division multiplexed (Step S101). The optical transmission path 4 (first transmission path) in the preceding stage of the phase conjugate conversion unit 5a transmits a first optical signal (Step S102).

The phase conjugate conversion unit 5a generates a second optical signal (phase conjugate light) by inverting the spectrum of the first optical signal (Step S103). The optical transmission path 4 (second transmission path) in a subsequent stage of the phase conjugate conversion unit 5a transmits a second optical signal (Step S104). The optical relay unit 3 may amplify and relay the second optical signal (Step S105). The reception unit 6 receives the phase conjugate light from the optical transmission path 4 (second transmission path) (Step S106).

As described above, the transmission unit 2 maximizes the frequency intervals between the plurality of channel components within the transmission band. The transmission unit 2 generates a first optical signal (wavelength multiplexed signal) that is an optical signal in which a plurality of channel components are wavelength-division multiplexed. In the first transmission path (for example, optical transmission path 4-1), the first optical signals are transmitted. The phase conjugate conversion unit 5a generates a second optical signal (phase conjugate light) by inverting the spectrum of the first optical signal. In the second transmission path (for example, optical transmission path 4-2), a second optical signals are transmitted. The first transmission path wavelength-disperses a plurality of channel components of the first optical signal. The second transmission path wavelength-disperses a plurality of channel components of the second optical signal.

The first transmission path (for example, the optical transmission path 4-3) may include one or more first optical relay units (for example, the optical relay unit 3-1) for amplifying and relaying the first optical signal. The second transmission path (for example, the optical transmission path 4-4) may include one or more second optical relay units (for example, the optical relay unit 3-2) for amplifying and relaying the second optical signal. The number of the first optical relay units in the preceding stage of the phase conjugate conversion unit 5a and the number of the second optical relay units in the subsequence stage of the phase conjugate conversion unit 5a may be equal.

Thus, since the influence of the cross-phase modulation on the nonlinear phase noise is reduced and the noise derived from the self-phase modulation becomes more dominant, the performance of compensating for the nonlinear phase noise by the phase conjugate conversion is maximized. This makes it possible to improve the transmission distance of the optical signal.

### Second Embodiment

In the second embodiment, the difference from the first embodiment is that the optical transmission system 1 includes, for example, 12-span optical transmission path 4. In the second embodiment, differences with the first embodiment will be mainly described.

The optical transmission system 1 according to the second embodiment includes, as an example, one transmission unit 2, five optical relay units 3, the 12-span optical transmission path 4, six phase conjugate conversion units 5a, and one reception unit 6.

In the optical transmission system 1 in the second embodiment, amplification relay is executed 12 (=5+6+1) times in total by five optical relay units 3, six phase conjugate conversion units 5a, and one reception unit 6. The phase conjugate conversion unit 5a executes phase conjugate conversion every two spans like the phase conjugate conversion unit 5a illustrated in FIG. 1.

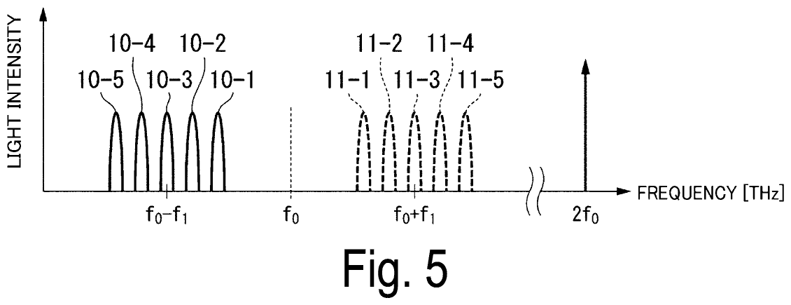

FIG. 5 is a diagram illustrating an example of frequency arrangement (frequency dependence) of an optical signal before phase conjugate conversion and an optical signal after phase conjugate conversion in the second embodiment. The transmission unit 2 transmits a wavelength multiplexed signal in which channel components of five waves are multiplexed on the low frequency side of the center frequency “f₀” of optical parametric amplification to the phase conjugate conversion unit 5a. The center frequency “f₀−f₁” of the wavelength multiplexed signal is 192.5 THz. The center frequency “f₀” of the optical parametric amplification used as the phase conjugate conversion is 194 THz. The frequency “f₀+f₁” of the phase conjugate light generated by the phase conjugate conversion is 195.5 THz. The nonlinear medium is, for example, a second-order nonlinear medium. Therefore, the frequency of the excitation light is the second harmonic “2f₀” (=388.0 THz) of the center frequency.

A channel component 10 is a channel component of the wavelength multiplexed signal input to the phase conjugate conversion unit 5a. A channel component 11 is a channel component of the wavelength multiplexed signal outputted from the phase conjugate conversion unit 5a.

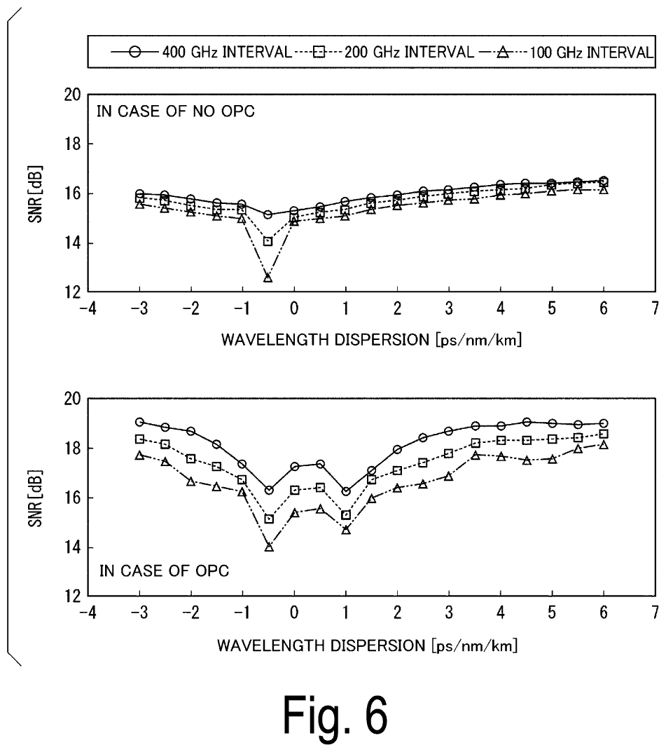

FIG. 6 is a diagram illustrating a relationship example (numerical analysis result) between wavelength dispersion and a signal-to-noise ratio in the second embodiment. The vertical axis indicates a signal-to-noise ratio (quality of a received wavelength multiplexed signal). The horizontal axis indicates the wavelength dispersion of the wavelength multiplexed signal at the local wavelength 1550 nm.

In FIG. 6, the length of the optical transmission path 4 (optical fiber) is 80 km. A long distance transmission of 960 km is executed by a total of 12 amplification relays. The dispersion slope of the optical transmission path 4 as a transmission medium is, for example, 0.07 ps/nm²/km. The dispersion slope is a wavelength derivative of wavelength dispersion. The nonlinear optical constant is, for example, 2.3/W/km. As an example, the propagation loss is 0.23 dB/km.

The noise factor of the amplification repeater (the optical relay unit 3 and the phase conjugate conversion unit 5a) is, for example, 4.5 dB. The modulation format of the wavelength multiplexed signal is, for example, 32 Gbaud dual polarization differential quadra-ture phase shift keying (DP-QPSK). The power (optical intensity) of the wavelength multiplexed signal input to the optical transmission path 4 is determined to be a power value at which the signal-to-noise ratio becomes the highest among the respective dispersion conditions.

The intervals of the channel components 10 are three kinds of 100 GHz, 200 GHz, and 400 GHz. Similarly, the interval of the channel components 11 is three, that is, 100 GHz, 200 GHz, and 400 GHz.

In a case where the phase conjugate conversion is not performed (in a case where the phase conjugate conversion unit 5a performs only amplification and does not perform phase conjugate conversion), it was confirmed that the transmission performance deteriorates most in a case where the wavelength dispersion is “−0.5 ps/nm/km”. Here, the local wavelength dispersion at the center frequency (center wavelength) of the input wavelength multiplexed signal becomes almost 0 in accordance with the dispersion slope of the optical transmission path 4.

Since the wavelength dispersion is small, the influence of walk-off is small. Since the influence of walk-off is small, the generation efficiency of phase noise caused by cross-phase modulation is large. Therefore, the transmission performance is deteriorated. The amount of deterioration in transmission performance is smaller when the interval of the channel components 11 is 400 GHz compared with the case where the interval of the channel components 11 is 100 GHz. This is because the effect of the cross-phase modulation is reduced by the expansion of the interval of the channel components.

In a case where the phase conjugate conversion (in a case where the phase conjugate conversion unit 5a performs optical parametric amplification used as phase conjugate conversion) is performed, the transmission performance is degraded at wavelength dispersion of “−0.5 ps/nm/km” and wavelength dispersion of “1.0 ps/nm/km”.

The reason why the transmission performance deteriorates in a case where the wavelength dispersion is “−0.5 ps/nm/km” is the same as the reason when the phase conjugate conversion is not performed. The reason why the transmission performance deteriorates even in a case where the wavelength dispersion is “1.0 ps/nm/km” is that the local wavelength dispersion becomes 0 in the band of the phase conjugate light generated by the phase conjugate conversion.

Therefore, in order to reduce the influence of the cross-phase modulation in the optical transmission system 1 performing the phase conjugate conversion, it is necessary to select a transmission medium so that the wavelength dispersion of the optical transmission path 4 becomes sufficiently large in both the band of the wavelength multiplexed signal and the band of the phase conjugate light.

Specifically, the absolute value of wavelength dispersion in both the band of the wavelength multiplexed signal and the band of the phase conjugate light is, for example, 2 ps/nm/km or more. The zero-dispersion wavelength of standard single mode fibers often used in long-distance transmission is about 1.30 μm. Since the band of zero-dispersion wavelength “1.30 μm” satisfies this requirement because it is far from the commonly used band “C-band”.

The zero-dispersion wavelength of the non-zero dispersion shifted fiber exists near 1.50 μm. The non-zero dispersion shifted fibers are also often used as a transmission medium. However, when the non-zero dispersion shifted fibers are used as a transmission medium, the wavelength of the phase conjugate light generated by the phase conjugate conversion (the wavelength of the optical signal after the phase conjugate conversion) is close to the zero-dispersion wavelength. Therefore, it is necessary to determine the wavelength of the phase conjugate light so that the absolute value of the wavelength dispersion is not less than “2 ps/nm/km”.

The wavelength of the phase conjugate light is determined according to the phase matching condition of the medium of optical parametric amplification used as the phase conjugate conversion. When the results in the case where the interval of channel components is 400 GHz are compared with each other, in the optical transmission system 1 that performs phase conjugate conversion, the amount of degradation is greater when the wavelength dispersion is “−0.5 ps/nm/km” compared to the optical transmission system that does not perform phase conjugate conversion. Such an increase in the amount of deterioration indicates that the influence of phase noise derived from the cross-phase modulation becomes larger by the use of the phase conjugate conversion.

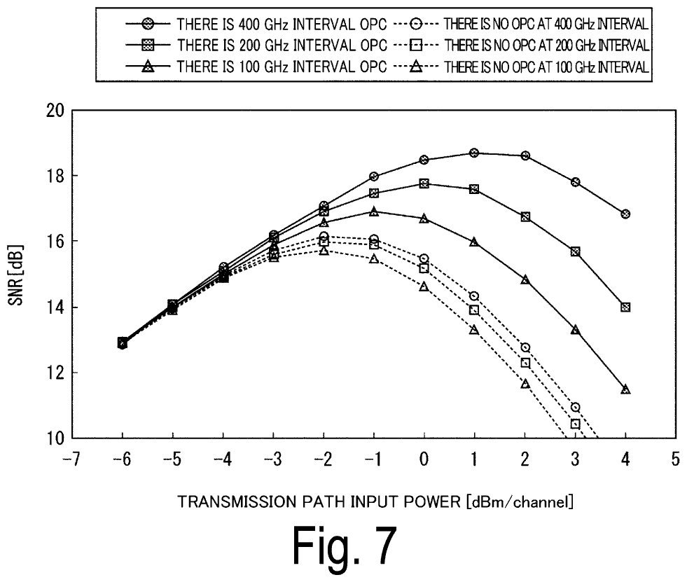

FIG. 7 is a diagram illustrating an example of a relationship between transmission path input power and signal-to-noise ratio in the second embodiment. Specifically, the characteristic of the optical intensity (transmission path input power) of the wavelength multiplexed signal inputted to the transmission path is illustrated in a case where the wavelength dispersion of the transmission medium at the wavelength of “1,550 nm” is “3 ps/nm/km”.

In a case where the phase conjugate conversion is not executed (“NO OPC”), the amount of improvement in the transmission performance due to the expansion of the interval of the channel components is not so large. This is because the walk-off of the nonlinear phase noise due to the cross-phase modulation is caused by the wavelength dispersion, so that the nonlinear phase noise derived from the self-phase modulation becomes relatively dominant.

In a case where the phase conjugate conversion is executed (“There is OPC”), walk-off of nonlinear phase noise due to cross-phase modulation is small. Therefore, in the optical transmission system 1 which performs phase conjugate conversion, the transmission performance greatly changes according to the interval of the channel components. This indicates that the phase noise derived from self-phase modulation is greatly reduced by the phase conjugate transformation, and that the phase noise derived from cross-phase modulation is dominant by the walk-off.

Therefore, in order to maximize the transmission performance of the optical transmission system 1 which performs the phase conjugate conversion, it is important that the interval between the channel components is set as large as possible. Actually, the longer the interval between the channel components is, the smaller the number of the channel components is required. For this reason, it is necessary to maximize the interval between the channel components in view of the required number of channels.

As described above, the transmission unit 2 secures the number of channels required in the optical transmission system 1, and maximizes the interval between a plurality of channel components within the transmission band. This makes it possible to improve the transmission distance of the optical signal.

### Third Embodiment

In a third embodiment, the difference from the first embodiment is that the optical transmission system 1 includes a complementary spectral inversion (CSI) phase conjugate conversion unit. In the third embodiment the differences from the first embodiment will be described mainly.

The optical transmission system 1 according to the third embodiment includes the transmission unit 2, the plurality of optical relay units 3, the plurality of optical transmission paths 4, one or more phase conjugate conversion units 5b, and the reception unit 6.

The band of the phase conjugate light needs to be set. Therefore, on the frequency axis, the wavelength multiplexed signal can be arranged only on either the low frequency side or the high frequency side with the center frequency “f₀” of the band of optical parametric amplification as a reference. The band that can be used for signal transmission is half the band of optical parametric amplification used as phase conjugate conversion.

Therefore, the bandwidth in which the necessary number of channel components “N” can be arranged is “B/2” with respect to the bandwidth “B” of the optical parametric amplification. In addition, the interval at which channel components can be secured is also “B/2N”. In order to avoid this, the optical transmission system 1 in the third embodiment is provided with the phase conjugate conversion unit 5b as a complementary spectrum inversion type phase conjugate conversion unit.

The phase conjugate conversion unit 5b may have a configuration similar to that of a complementary spectrum inversion part shown in Reference 2 (Japanese Patent Application Laid-Open No. 2016-218173).

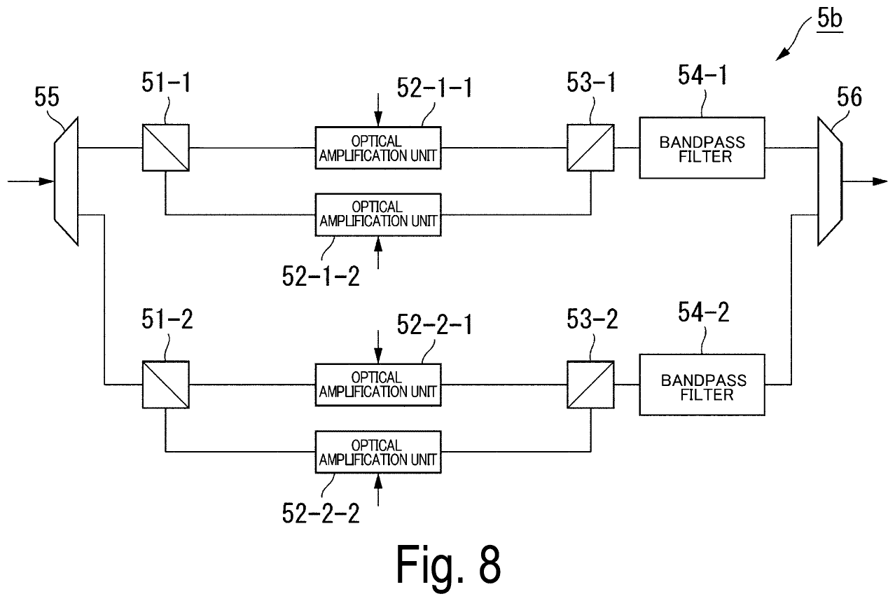

FIG. 8 is a diagram illustrating a configuration example of a phase conjugate conversion unit (complementary spectrum inversion type phase conjugate conversion unit) in the third embodiment. The optical transmission system 1 includes two polarization demultiplexing units 51, four optical amplification units 52, two polarization multiplexing units 53, two bandpass filters 54, a band demultiplexing unit 55, and a band multiplexing unit 56.

A channel component having a single wavelength is input to the band demultiplexing unit 55. The band demultiplexing unit 55 divides a band of a channel component of a single wavelength into a first band and a second band with a center frequency “f₀” of optical parametric amplification by the optical amplification unit 52 as a boundary. For example, the channel component of the first band is input to the polarization demultiplexing unit 51-1. The channel component of the second band is inputted to a polarized wave demultiplexing unit 51-2.

Nonlinear optical effects, including the process of optical parametric amplification, are polarization dependent. Therefore, the polarization demultiplexing unit 51 demultiplexes the input channel component into a first polarization component and a second polarization component. Here, the first polarization component and the second polarization component are orthogonal to each other. The polarization demultiplexing unit 51 uses, for example, a polarization beam splitter to demultiplex an optical signal into a first polarization component and a second polarization component.

Excitation light is input to the nonlinear medium of the optical amplification unit 52. In the phase conjugate conversion unit 5a, the optical amplification unit 52 performs spectrum inversion for each demultiplexed polarization component with a center frequency “f₀” of optical parametric amplification as a symmetry axis (boundary).

A first polarization component is input from the polarization demultiplexing unit 51 to a nonlinear medium of the optical amplification unit 52-1-n (n is an integer of 1 or more). A second polarization component is input from the polarization demultiplexing unit 51 to the nonlinear medium of the optical amplification unit 52-1-(n+1). The same applies to the optical amplification unit 52-2.

The optical amplification unit 52 multiplexes the input polarization component and the excitation light using, for example, a dichroic mirror. The optical amplification unit 52 may multiplex the input polarization component and the excitation light using, for example, a wavelength multiplexing coupler. Each polarization component is amplified by optical parametric amplification by the nonlinear medium of the optical amplification unit 52. In this case, the phase conjugate light is generated in a symmetrical band with a center frequency “f₀” of optical parametric amplification as a symmetrical axis (boundary).

The polarization multiplexing unit 53 multiplexes each polarization component using a polarization beam combiner or the like. The bandpass filter 54 passes the optical signal of the spectrum-inverted band out of the multiplexed optical signals of the polarization component. In this manner, the bandpass filter 54 deletes the optical signal (channel component other than the phase conjugate light) of the band which is not spectrum-inverted from the multiplexed polarization component. That is, the bandpass filter 54 extracts an optical signal (phase conjugate light) of a band in which the spectrum is inverted from the multiplexed polarization component.

The band multiplexing unit 56 multiplexes a channel component having a single wavelength in the first band and a channel having a single wavelength in the second band. This can provide an effect as described below. The phase conjugate light is a light obtained by inverting the spectrum of an input wavelength multiplexed signal (original optical signal) with a center frequency of a band of optical parametric amplification as a symmetry axis.

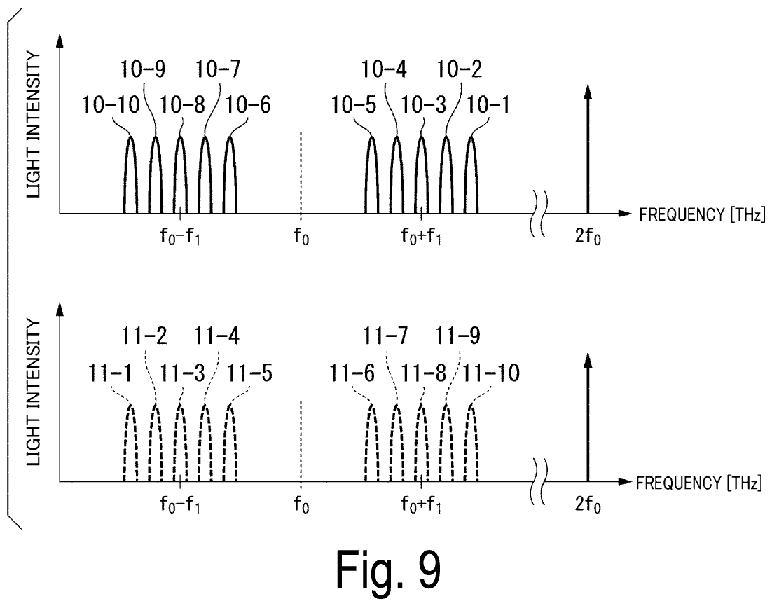

FIG. 9 is a diagram illustrating an example of the frequency arrangement of the optical signal before the phase conjugate conversion and the optical signal after the phase conjugate conversion in the third embodiment. In the upper stage of FIG. 9, a total of 10 wave wavelength multiplexed signals before phase conjugate change are arranged on the frequency axis by 5 waves with the center frequency “f₀” of the band of optical parametric amplification as a symmetry axis (boundary). In the lower stage of FIG. 9, a total of 10 wave wavelength multiplexed signals after phase conjugate change are arranged on the frequency axis by 5 waves with the center frequency “f₀” of the band of optical parametric amplification as a symmetry axis (boundary).

As described above, the phase conjugate conversion unit 5b is a complementary spectrum inversion type phase conjugate conversion unit. Thus, since the wavelength multiplexed signals are arranged on both the low frequency side and the high frequency side with the center frequency of the band of optical parametric amplification as a reference, the transmission distance of the optical signal can be further improved. Since the interval of channel components is maximized for the entire band of optical parametric amplification, the transmission distance of the optical signal can be further improved.

### (Hardware Configuration Example)

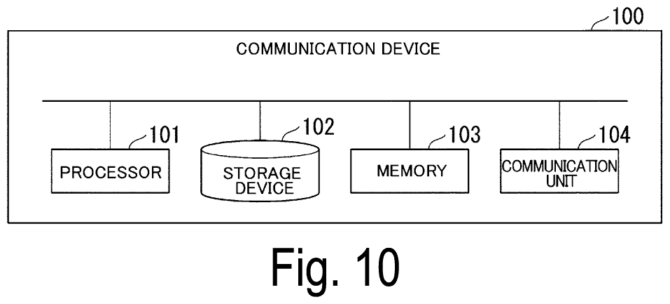

FIG. 10 is a diagram illustrating a hardware configuration example of a communication device (transmission unit) (reception unit) in each embodiment. A communication device 100 corresponds to at least one of a transmission unit and a reception unit in each embodiment. The communication device 100 generates or processes data to be transmitted using the optical signal. Some or all of functional units of the communication device 100 is realized as software by a processor 101 such as a central processing unit (CPU) executing a program stored in a storage device 102 having a nonvolatile recording medium (non-transitory recording medium) and a memory 103. A program may be recorded on a computer-readable non-transitory recording medium. Examples of the computer-readable recording medium include a portable medium such as a flexible disc, a magneto-optical disc, a read only memory (ROM), or a compact disc read only memory (CD-ROM), and a non-transitory recording medium such as a storage device including a hard disk incorporated in a computer system. A communication unit 104 executes the predetermined communication processing. The communication unit 104 may acquire data and a program.

A part or all of the functional units of the communication device 100 may be implemented, using hardware including an electronic circuit or circuitry in which a large scale integrated circuit (LSI), an application specific integrated circuit (ASIC), a programmable logic device (PLD), a field programmable gate array (FPGA), or the like is used.

Although the embodiment of the present invention has been described in detail with reference to the drawings, a specific configuration is not limited to this embodiment, and design within the scope of the gist of the present invention, and the like are included.

### INDUSTRIAL APPLICABILITY

The present invention is applicable to optical transmission systems (optical communication systems).

### REFERENCE SIGNS LIST

1 Optical transmission system
2 Transmission unit
3 Optical relay unit
4 Optical transmission path
5a, 5b Phase conjugate conversion unit
6 Reception unit
10 Channel component
11 Channel component
51 Polarization demultiplexing unit
52 Optical amplification unit
53 Polarization multiplexing unit
54 Bandpass filter
55 Band demultiplexing unit
56 Band multiplexing unit
100 Communication device
101 Processor
102 Storage device
103 Memory
104 Communication unit

1. An optical transmission system, comprising:
a transmitter that maximizes a frequency interval between a plurality of channel components within a transmission band, and generates a first optical signal that is an optical signal in which the plurality of channel components are wavelength-division multiplexed;
a first transmission path for transmitting the first optical signal;
a phase conjugate converter that generates a second optical signal by inverting a spectrum of the first optical signal; and
a second transmission path for transmitting the second optical signal.

2. The optical transmission system according to claim 1, wherein the first transmission path wavelength-disperses the plurality of channel components of the first optical signal, and
the second transmission path wavelength-disperses the plurality of channel components of the second optical signal.

3. The optical transmission system according to claim 1, wherein the first transmission path includes one or more first optical relays that amplify and relay the first optical signal,
the second transmission path includes one or more second optical relays that amplify and relay the second optical signal, and
the number of the first optical relays is equal to the number of the second optical relays.

4. An optical transmission method to be executed by an optical transmission system, the method comprising:
maximizing a frequency interval between a plurality of channel components within a transmission band, and generating a first optical signal that is an optical signal in which the plurality of channel components are wavelength-division multiplexed;
transmitting the first optical signal;
generating a second optical signal by inverting a spectrum of the first optical signal; and
transmitting the second optical signal.

5. A non-transitory computer readable medium which stores a program for causing a computer to serve as the optical transmission system according to claim 1.
